(19) United States
(12) Patent Application Publication
(10) Pub. No.: US 2009/0037610 A1
(43) Pub. Date: Feb. 5, 2009

(54) Electronic device interface control system

(76) Inventors: Robort E. Krancher, Houston, TX (US); Darrell L. Brokmeyer, Magnolia, TX (US); Jennifer E. Rios, Spring, TX (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/888,398

(22) Filed: Jul. 31, 2007

(51) Int. Cl. G06F 3/00

(52) U.S. Cl. 710/10

(57) ABSTRACT

An electronic device interface control method comprising identifying at least one peripheral device coupled to an electronic device and determining whether to disable an interface corresponding to the at least one peripheral device based on the identity of the at least one peripheral device.

### BACKGROUND

Electronic devices generally comprise ports and/or interfaces to which external and/or peripheral devices may be connected. For security purposes, administrators of the electronic device may disable the ports and/or interfaces to prevent computer viruses from being downloaded onto the electronic device. However, once the ports and/or interfaces are disabled, external and/or peripheral devices are unable to interface with the electronic device via such ports and/or interfaces.

### BRIEF DESCRIPTION OF THE DRAWINGS

FIG. 1 is a block diagram of an electronic device in which an interface control system is employed to advantage; and

FIG. 2 is a flowchart illustrating an embodiment of an interface disabling method for an electronic device.

### DETAILED DESCRIPTION OF THE DRAWINGS

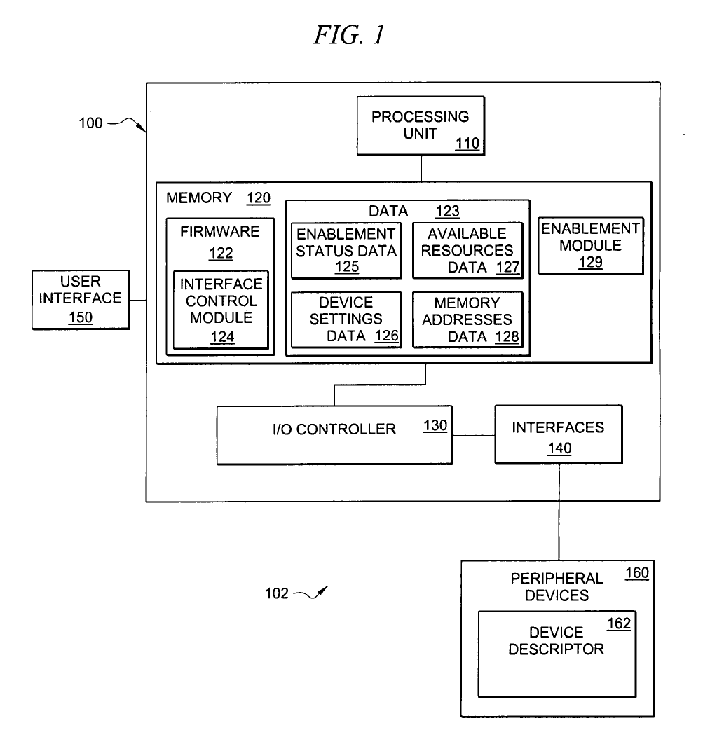

FIG. 1 is a block diagram of an electronic device 100 comprising an embodiment of an interface control system 102. In the illustrated embodiment, interface control system 102 is configured to dynamically enable and/or disable at least one interface based on a type, function, and/or class of peripheral device coupled to the interface. Electronic device 100 can be any type of electronic device such as, but not limited to, a laptop computer, a tablet computer, a personal digital assistant (PDA), a cellular phone, a gaming device, a desktop computer, or any other type of portable or non-portable electronic device. In FIG. 1, a user interface 150 and a peripheral device(s) 160 are illustrated as being coupled to electronic device 100. User interface 150 is any module and/or component (e.g., a display screen, a keyboard, a mouse, etc.) configured to enable a user to input information to and/or receive information from electronic device 100. User interface 50 may form part of electronic device 100 or be couplable to electronic device 100. Peripheral device(s) 160 can be any type of peripheral device, such as, but not limited to a Universal Serial Bus (USB) device, a Peripheral Component Interconnect (PCI) device, a PCI Express device, a gigabit Ethernet device, a cardbus controller, a wireless local area network (LAN) controller, an audio compression/decompression (CODEC), and a super I/O controller.

In the illustrated embodiment, electronic device 100 comprises a processor unit 110, a memory 120, an input/output (I/O) controller 130, and an interface(s) 140. Processor unit 110 is used to execute the instructions and/or commands associated with dynamically enabling and/or disabling at least one interface 140 to which peripheral device(s) 160 is coupled based on a type, function, and/or class of peripheral device(s) 160. Memory 120 is a storage element configured to store the modules, instructions, commands, and/or data in which processor unit 110 uses to dynamically enable and/or disable at least one interface 140. I/O controller 130 manages communications and/or processes between memory 120 and interface(s) 140. Interface(s) 140 is a set of one or more ports, connectors, etc. configured to be coupled to corresponding peripheral device(s) 160.

In the illustrated embodiment, memory 120 comprises a firmware 122, data 123, and an enablement module 129. In some embodiments, firmware 122 is a set of read-only instructions used to perform initialization processes for electronic device 100 (e.g., using a basic input/output system (BIOS)) and/or facilitate communications processes between various components within electronic device 100 (e.g., device driver, operating system, etc.). In the illustrated embodiment, firmware 122 comprises an interface control module 124 configured to enable a user to select and/or otherwise set various criteria to enable automatic enabling/disabling of at least one of interface(s) 140. In FIG. 1, interface control module 124 is shown to be in firmware 122; however, it should be understood that, in alternative embodiments, interface control module 124 may be otherwise stored (e.g., a hard disk drive, a flash drive, etc.). It should be understood that all or portions of interface control module 124 may comprise hardware, software, firmware, or a combination thereof.

In FIG. 1, memory 120 comprises data 123 in the form of databases and/or other forms of data (e.g., tables, worksheets, charts, etc.) for enabling and/or disabling at least one of interface(s) 140 to which peripheral device(s) 160 is coupled. In the illustrated embodiment, data 123 comprises enablement status data 125, device setting(s) data 126, available resources data 127, and memory addresses data 128. Enablement status data 125 comprises information associated with an operational condition (e.g., on or off, enabled or disabled, etc.) of interface(s) 140 in electronic device 100. In the illustrated embodiment, enablement status data 125 can hold and/or comprise any type of indicator (e.g., a binary value, a software code, etc.). In some embodiments, enablement status data 125 is set to an enabled state or a disabled state each time electronic device 100 is initialized. Device setting(s) data 126 comprises information and/or a list of peripheral device(s) 160 coupled to electronic device 100 via interface(s) 140. In some embodiments, device setting(s) data 126 comprises information associated with each peripheral device 160 identified and coupled to electronic device 100 such as the type, function, and/or class of the corresponding peripheral device(s) 160. Device settings data 126 may also comprise information indicating whether a particular interface 140 should be enabled and/or disabled based on a particular peripheral device 160 detected and/or identified as coupled to electronic device 100 (e.g., settings and/or criteria indicating that a particular interface 140 is to be disabled if particular type of peripheral device(s) 160 is detected and/or identified as being coupled to electronic device 100). Available resources data 127 comprises information associated with a list of interface(s) 140 and corresponding peripheral device(s) 160 coupled to interface(s) 140 having an enabled status, thereby making the corresponding peripheral device(s) 160 available for use by a user of electronic device 100 and/or components in electronic device 100. Memory addresses data 128 comprises information associated with identifying and/or indicating a location in memory 120 configured to identify which interface(s) 140 in electronic device 100 to enable and/or disable.

In the illustrated embodiment, enablement module 129 is configured to enable and/or disable interface(s) 140. For example, in some embodiments, enablement module 129 enables and/or disables interface(s) 140 based on the enablement status for the corresponding interface(s) 140 stored as enablement status data 125. In some embodiments, enablement module 129 triggers and/or flips a power switch configured to enable a current to flow and/or stop flowing to the corresponding interfaced(s) 140. In alternative embodiments, enablement module 129 allocates and/or prevents space and/or resources of memory 120 from being allocated to, respectively, enable and/or disable the corresponding interface(s) 140. Thus, in this embodiment, enablement module 129 maps and/or does not map an electrical path to a memory address for the corresponding interface(s) 140 to control access and/or communication via such interface(s) 140. It should be understood that enablement module 129 may comprise hardware, software, firmware, or a combination thereof.

In the illustrated embodiment, peripheral device(s) 160 comprise a device descriptor(s) 162 which provides certain identification information associated with the peripheral device 160, such as the type (e.g., a printer, an audio device, a speaker, a keyboard, a mouse, a graphics tablet, a game controller, a trackball, a touchpad, a laptop eraser, etc.), function (e.g., a human interface device, a wireless device, an audio device, a mass storage device, a communications device, a serial bus controller, etc.), and/or class (e.g., a USB-class device, a PCI-class device, etc.) of corresponding peripheral device(s) 160. It should be understood that device descriptor(s) 162 may also comprise other types of information and/or identifiers.

Thus, in some embodiments of operation, firmware 122 executes interface control module 124 during initialization processes to enable a user to select and/or set various criteria used to enable and/or disable one or more interface(s) 140 based on at least one device descriptor(s) 162 for peripheral device(s) 160. In this embodiment, upon initialization, interface control module 124 identifies peripheral device(s) 160 coupled to electronic device 100 by reading device descriptor(s) 162 to identify the type, function, and/or class of peripheral device(s) 160 and the corresponding interface(s) 140 to which peripheral device(s) 160 are coupled to electronic device 100. Interface control module 124 then correlates the corresponding interface(s) 140 with a memory address stored in memory addresses data 128. Interface control module 124 stores the information associated with peripheral device(s) 160 (e.g., the type, function, class, memory address, etc.) as device setting(s) data 126. In some embodiments, interface control module 124 then compares the identified peripheral device(s) 160 with an enablement status listed in enablement status data 125 for the corresponding peripheral device(s) 160. Interface control module 124 then executes enablement module 129 to enable and/or disable corresponding interface(s) 140. In some embodiments, interface(s) 140 is by default enabled upon initialization of electronic device 100, and, therefore, no further action by enablement module 129 may be necessary other than maybe executing instructions and/or processes to disable interface(s) 140 with a “disable” status. In some embodiments, interface control module 124 then presents and/or makes available the resources listed in available resources data 127 to a user and/or other components in electronic device 100. In some embodiments, interface control module 124 then stores in available resources data 127 the corresponding peripheral device(s) 160 having an interface(s) 140 having an enablement status of “enabled” in enablement status data 125.

In some embodiments, interface control module 124 is configured to prompt a user to determine and/or identify which peripheral device(s) 160 to enable and/or disable. In some embodiments, interface control module 124 formats and presents on user interface 150 a list of peripheral device(s) 160 and/or the type, function, and/or class of the peripheral device(s) 160 from which a user may select and/or set various criteria for enablement/disablement. In some embodiments, a user can then specify which of interface(s) 140 to enable and/or disable based on the type and/or identity of certain peripheral device(s) 160. Alternatively, the user can specify a group of interface(s) 140 to enable and/or disable based on the function and/or class of peripheral device(s) 160. In response to the user selecting and/or identifying which interface(s) 140 to enable and/or disable, interface control module 124 assigns an enablement status for each of the enabled interface(s) 140 to form enablement status data 125. In some embodiments, interface control module 124 only assigns an enablement status for interface(s) 140 having a disable value because the enablement status for interface(s) 140 defaults to an enabled status and vice-versa. Alternatively, interface control module 124 can assign an enablement status for interface(s) 140 regardless of the current value existing in enablement status data 125. Interface control module 124 then stores in available resources data 127 the corresponding peripheral device(s) 160 having interface(s) 140 having an enablement status of “enabled” in enablement status data 125. Interface control module 124 then executes enablement module 129 to enable and/or disable corresponding interface(s).

Embodiments of interface control system 102 are also configured to enable a user and/or administrator to change an enablement status for a particular peripheral device 160 after electronic device 100 initializes and/or is operating normally. In this embodiment, the user and/or administrator inputs a series of commands and/or keystrokes (e.g., a function key, a ctrl plus letter key, etc.) which executes interface control module 124. In response to receiving and identifying the command as a request to selectively enable and/or disable at least one interface(s) 140, interface control module 124 presents device setting(s) data 126 to a user and/or administrator on user interface 150. The user and/or administrator then identifies and/or selects which interface(s) 140 of which to change enablement status. After entering the changes, interface control module 124 executes enablement module 129 to implement the changes.

Embodiments of interface control system 102 are configured to dynamically control the enable/disable status of interface(s) 140. For example, in some embodiments, in response to a new peripheral device(s) 160 being coupled to interface(s) 140 subsequent to initialization of electronic device 100, interface control module 124 identifies the new peripheral device(s) 160 and automatically disables the corresponding interface 140 based on the identity of new peripheral device(s) 160 (e.g., using device settings data 126). In some embodiments, interface control module 124 notifies the user and/or administrator of the new peripheral device(s) 160 and can prompt the user and/or administrator to assign an enablement status to a corresponding interface(s) 140 to which the new peripheral device(s) 160 is coupled (e.g., disabling the interface 140 until and/or unless another is to enable). It should be understood that, in this embodiment, enablement module 129 enables and/or disables interface(s) 140 by allocating and/or preventing resources of memory 120 from being allocated to interface(s) 140. Alternatively, in the embodiment in which enablement module 129 enables and/or disables interface(s) 140 by triggering and/or flipping a power switch, interface control system 102 recognizes new peripheral device(s) 160 during initialization processes for electronic device 100.

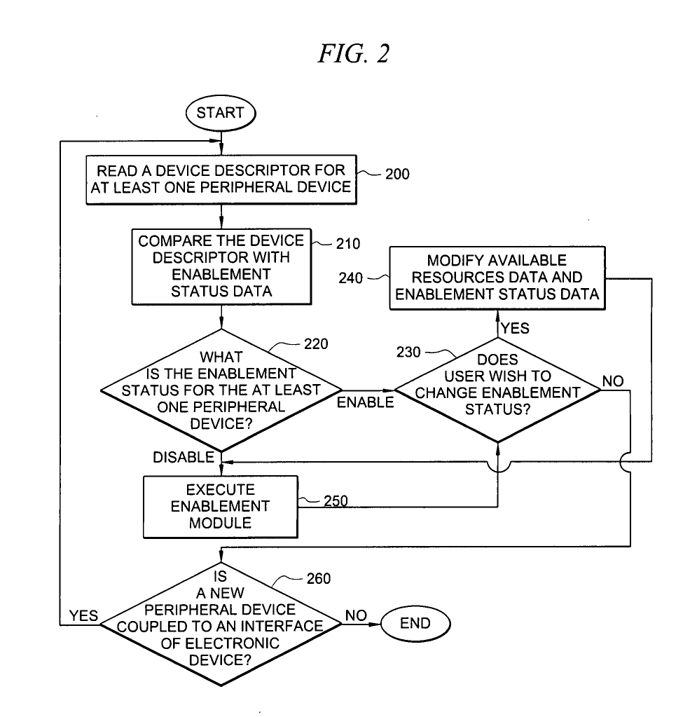

FIG. 2 is a flowchart illustrating an embodiment of an interface control method for electronic device 100. The method begins with block 200 with interface control module 124 reading device descriptor(s) 162 for at least one peripheral device 160 coupled to interface(s) 140 of electronic device 100. Interface control module 124 then compares device descriptor(s) 160 with an enablement status in enablement status data 125 (block 210). Interface control module 124 then determines the enablement status for the at least one peripheral device 160 (decision block 220). If interface(s) 140 for the at least one peripheral device 160 is set to enable (“enable” output to decision block 220), then interface control module 124 prompts the user to determine whether the user wishes to change the enablement status for the at least one peripheral device 160 (decision block 230). If the user wishes to change the enablement status (“yes” output to decision block 230), then interface control module 124 modifies available resources data 127 and enablement status data 125 to reflect the new enablement status (block 240). Interface control module 124 then executes enablement module 250 to implement the identified enablement status (block 250). Interface control module 124 then determines whether a new peripheral device 160 is coupled to interface(s) 140 of electronic device 100 (block 260). If a new peripheral device 160 is coupled to electronic device 100 (“yes” output to decision block 260), the method returns to block 200 to be repeated. If, however, a new peripheral device 160 is not coupled to electronic device 100 (“no” output to block 260), the method terminates thereafter. Returning to decision block 230, if a user does not wish to change an enablement status (“no” output to decision block 230), then the method proceeds to block 260 thereafter. Returning to decision block 220, if the enablement status for the at least one peripheral device 160 is disable (“disable” output to decision block 220), the method proceeds to block 250 thereafter.

The illustrated embodiments may be implemented in software and can be adapted to run on different platforms and operating systems. In particular, functions implemented by interface control system 102, for example, may be provided by an ordered listing of executable instructions that can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate or transport the program for use by or in connection with the instruction execution system, apparatus, or device. The computer-readable medium can be, for example, but is not limited to, an electronic, magnetic, optical, electro-magnetic, infrared, or semi-conductor system, apparatus, device, or propagation medium.

The illustrated embodiments provide a method, apparatus, and computer-readable medium for controlling enablement status 125 for one or more peripheral device(s) 160. Embodiments of electronic device 100 are configured to enable a user and/or administrator to change enablement status 125 based on a device type and/or device descriptor 162 for each peripheral device 160. Therefore, users and/or administrators can still prevent computer viruses from being downloaded onto electronic device 100 and still maintain the flexibility to use a particular interface(s) 140 at a later time.

1. An electronic device interface control method, comprising:
identifying at least one peripheral device coupled to an electronic device; and
determining whether to disable an interface corresponding to the at least one peripheral device based on the identity of the at least one peripheral device.

2. The method of claim 1, further comprising interrupting a current flow to the interface based on the identity of the at least one peripheral device.

3. The method of claim 1, further comprising preventing memory resources from being allocated for interface based on the identity of the at least one peripheral device.

4. The method of claim 1, further comprising reading a device descriptor for the at least one peripheral device.

5. The method of claim 1, further comprising determining a device descriptor for the at least one peripheral device.

6. The method of claim 1, further comprising initiating an interface control module when the electronic device is initialized to determine whether to enable or disable the interface.

7. The method of claim 1, further comprising initiating an interface control module in response to a request by a user of the electronic device to change an enablement status for the at least one peripheral device.

8. The method of claim 1, further comprising enabling a user to identify an enablement status for the at least one peripheral device coupled to an interface of the electronic device based on a type of the at least one peripheral device.

9. An interface control system comprising:
an interface control module configured to identify at least one peripheral device coupled to an electronic device and determine whether to disable an interface corresponding to the at least one peripheral device based on the identity of the at least one peripheral device.

10. The system of claim 9, wherein the interface control module is configured to interrupt a current flow to the interface based on the identity of the at least one peripheral device.

11. The system of claim 9, wherein the interface control module is configured to prevent memory resources from being allocated for interface based on the identity of the at least one peripheral device.

12. The system of claim 9, wherein the interface control module is configured to read a device descriptor for the at least one peripheral device.

13. The system of claim 9, wherein the interface control module is configured to determine a device descriptor for the at least one peripheral device.

14. The electronic device of claim 9, wherein the interface control module is configured to initiate an interface control module when the electronic device is initialized to determine whether to enable or disable the interface.

13. (canceled)

14. (canceled)

15. The computer-readable medium of claim 21, wherein the instruction set, when executed by a processor, further causes the processor to prevent memory resources from being allocated for interface based on the identity of the at least one peripheral device.

16. The computer-readable medium of claim 21, wherein the instruction set, when executed by a processor, further causes the processor to read a device descriptor for the at least one peripheral device.

17. The computer-readable medium of claim 21, wherein the instruction set, when executed by a processor, further causes the processor to determine a device descriptor for the at least one peripheral device.

18. The computer-readable medium of claim 21, wherein the instruction set, when executed by a processor, further causes the processor to initiate an interface control module when the electronic device is initialized to determine whether to enable or disable the interface.

19. The computer-readable medium of claim 21, wherein the instruction set, when executed by a processor, further causes the processor to initiate an interface control module in response to a request by a user of the electronic device to change an enablement status for the at least one peripheral device.

20. The computer-readable medium of claim 21, wherein the instruction set, when executed by a processor, further causes the processor to enable a user to identify an enablement status for the at least one peripheral device coupled to an interface of the electronic device based on a type of the at least one peripheral device.

21. A computer-readable medium having stored thereon an instruction set to be executed, the instruction set, when executed by a processor, causes the processor to:
identify at least one peripheral device coupled to an electronic device; and
determine whether to disable an interface corresponding to the at least one peripheral device based on the identity of the at least one peripheral device.

22. The computer-readable medium of claim 21, wherein the instruction set, when executed by a processor, further causes the processor to interrupt a current flow to the interface based on the identity of the at least one peripheral device.
